(19) United States
(12) Patent Application Publication
(10) Pub. No.: US 2007/0013729 A1
(43) Pub. Date: Jan. 18, 2007

(54) Inkjet image forming apparatus and high resolution printing method

(75) Inventor: Myung-song Jung, Gunpo-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/471,636

(22) Filed: Jun. 21, 2006

(30) Foreign Application Priority Data
Jul. 13, 2005 (KR) 2005-63285

(51) Int. Cl. B41J 29/38

(52) U.S. Cl. 347/12

(57) ABSTRACT

An inkjet image forming apparatus and a high resolution printing method for the same. In the high resolution printing method, a printhead is moved with a predetermined motion amplitude in a stepwise manner to compensate for a malfunctioning nozzle or to perform a high resolution printing. Thus, a higher resolution image than an actual resolution of the printhead can be obtained and printing quality can be enhanced by compensating for a malfunctioning nozzle.

### CROSS-REFERENCE TO RELATED APPLICATIONS

This application claims the benefit of Korean Patent Application No. 2005-63285, filed on Jul. 13, 2005, in the Korean Intellectual Property Office, the disclosure of which is incorporated herein in its entirety by reference.

### BACKGROUND OF THE INVENTION

1. Field of the Invention

The present general inventive concept relates to an inkjet image forming apparatus, and more particularly, to a line printing type inkjet image forming apparatus which can compensate for malfunctioning nozzles and print with a resolution higher than an actual resolution of a printhead thereof.

2. Description of the Related Art

An inkjet image forming apparatus forms images by ejecting ink onto a print medium and can be classified as a shuttle type and a line printing type according to a printing method. The shuttle type inkjet image forming apparatus prints using a printhead that reciprocally moves in a direction that is perpendicular to a transferring direction of the print medium. The line printing type inkjet image forming apparatus prints using a printhead that has a nozzle unit with a length that corresponds to the width of the print medium.

In the line printing type inkjet image forming apparatus, the printhead is fixed and only the print medium is transferred. Accordingly, each nozzle disposed in the printhead ejects ink onto a fixed area on the print medium. If a nozzle in the printhead malfunctions, a missing line such as a white band appears on the print medium. That is, when a nozzle of the nozzle unit in the conventional inkjet image forming apparatus malfunctions, a missing line appears on the print medium. This printing defect typically does not matter when an image of a low printing density is formed. However, when printing a solid pattern or an image of a high printing density, the white line appears in the printed image along the transferring direction of the print medium, thereby substantially affecting the printing quality. In addition, a horizontal resolution of the inkjet image forming apparatus is physically determined by a distance between nozzles (i.e., a nozzle pitch) and a vertical resolution thereof is determined by a transferring speed of the print medium. Accordingly, when using the line printing type inkjet forming apparatus having the fixed printhead and a desired resolution for printing is higher than an actual resolution of the printhead, it is difficult to print an image with high resolution.

A method of compensating for the image quality degradation due to a malfunctioning nozzle is described in U.S. Pat. No. 5,581,284. The above-mentioned U.S. Patent describes a method of compensating for a malfunctioning nozzle in a line printing inkjet image forming apparatus. The malfunctioning nozzle is a nozzle that improperly ejects ink or a nozzle that does not eject ink at all. However, this method is useful to compensate for the malfunction of a nozzle that ejects black ink, but cannot be used to compensate for malfunction of nozzles that eject other color inks. Moreover, since the nozzles for cyan, magenta, and yellow ink do not operate when only the black color ink is printed, the process black can be formed using the cyan, the magenta, and the yellow ink from the nozzles. However, when a color image is printed, the nozzles for the cyan, the magenta, and the yellow ink operateand the compensation cannot be performed. In addition, color inks are used together to compensate for black ink using the process black, thereby increasing the use of the color inks with respect to the black ink. Therefore, a lifespan of the cartridge is also decreased.

Japanese Patent Publication No. 2001-301147 describes a method of enhancing a printing resolution, in which printing is performed by moving a printhead in units of a half nozzle pitch in a widthwise direction of the print medium. However, this method cannot compensate for a malfunctioning nozzle disposed in the printhead, since the printhead is only movable from an initial position by the half nozzle pitch. In addition, the printhead in this method ejects ink during a reciprocal motion between the initial position thereof and a half nozzle pitch position from the initial position, and thus a droplet direction of ink ejected from the initial position is opposite to the droplet direction of ink ejected from the half nozzle pitch position from the initial position. Accordingly, it is difficult to control the printhead to accurately eject ink on desired areas, which leads to unevenly printed areas. Due to the reciprocal motion of the printhead between the initial position thereof and the half nozzle pitch position from the initial position, it is possible to print with a resolution twice as high as the actual resolution of the printhead. However, it is impossible to enhance the resolution more than twice, since the printhead is only movable form the initial position by the half nozzle pitch. In addition, since the printhead is repeatedly reciprocally moved within a single nozzle pitch (i.e., by no more than the half nozzle pitch from the initial position in either direction), the motion of the printhead cannot be easily controlled.

### SUMMARY OF THE INVENTION

The present general inventive concept provides an image forming apparatus and a high resolution printing method that can print an image with higher resolution than an actual resolution of a printhead of the image forming apparatus.

The present general inventive concept also provides an image forming apparatus and a high resolution printing method that can reliably print an image by adjusting a motion amplitude of a printhead and an ink ejecting distance when compensating for malfunctioning nozzles or printing with high-resolution.

The present general inventive concept also provides an image forming apparatus and a high resolution printing method that can effectively compensate for image degradation caused by malfunctioning nozzles.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing an inkjet image forming apparatus including a print medium transferring unit to transfer a print medium in a first direction, a printhead having a nozzle unit with a length that corresponds to a width of the print medium installed along a second direction to eject ink onto the print medium to form an image, a carriage movably installed in the second direction and in which the printhead is installed, a carriage moving unit to reciprocally move the carriage in the second direction, a detecting unit to detect whether a malfunctioning nozzle exists in the nozzle unit, and a control unit to generate control signals to move the carriage by a single nozzle pitch “n” times with a motion amplitude in a range of more than a single nozzle pitch to the length of the nozzle unit when printing an image that corresponds to a single pixel line and a malfunctioning nozzle is detected, and to synchronously control the transferring operation of the print medium transferring unit, the ejecting operation of the printhead, and the operation of the carriage moving unit to compensate for the malfunctioning nozzle by ejecting ink when an adjacent nozzle is moved to a position where the malfunctioning nozzle is positioned for a previous ejection.

The control unit may generate a control signal to eject ink for compensation before the carriage arrives at a position that corresponds to a maximum motion amplitude.

The control unit may generate a control signal that drives only the adjacent nozzle that is moved to the position where the malfunctioning nozzle is positioned for the previous ejection.

The control unit may generate a control signal to control the carriage to have a motion amplitude of no more than five times a single nozzle pitch.

The foregoing and/or other aspects of the present general inventive concept are also achieved by providing an inkjet image forming apparatus including a print medium transferring unit to transfer a print medium in a first direction, a printhead having a nozzle unit with a length that corresponds to a width of the print medium installed along a second direction to eject ink onto the print medium to form an image, a carriage movably installed in the second direction and on which the printhead is installed, a carriage moving unit to reciprocally move the carriage in the second direction, and a control unit to generate control signals that move the carriage in a stepwise manner by a magnitude of D/N for “n” times with a motion amplitude in a range of more than a single nozzle pitch to the length of the nozzle unit when printing an image that corresponds to a single pixel line during a high resolution printing operation, and to synchronously control the transferring operation of the print medium transferring unit, the ejecting operation of the printhead, and the operation of the carriage to enhance a resolution by ejecting ink onto each position of a D/N interval between two adjacent nozzles, where “D” is a nozzle pitch, “n” is a predetermined natural number, and N is a ratio of a desired printing resolution to an actual resolution of the printhead.

The control unit may generate a control signal to eject ink at each time after the carriage is moved by more than a single nozzle pitch when printing with high resolution.

The apparatus may further include a detecting unit to detect whether a malfunctioning nozzle exists in the nozzle unit, and when a malfunctioning nozzle is detected, the control unit may generate a control signal to eject ink to compensate for the malfunctioning nozzle when an adjacent nozzle is moved to a position where the malfunctioning nozzle is positioned for a previous ejection.

The control unit may generate a control signal that drives only the adjacent nozzle that is moved to the position where the malfunctioning nozzle is positioned for the previous ejection.

The control unit may generate a control signal to eject ink to compensate before the carriage arrives at a position that corresponds to a maximum motion amplitude when the carriage has moved by a distance that is larger than a single nozzle pitch.

The control unit may generate a control signal to eject ink for the high resolution printing while the carriage is moved in reverse from the maximum motion amplitude.

The control unit may generate a control signal to eject ink to compensate for the malfunctioning nozzle during the high resolution printing after the carriage moves by more than a single nozzle pitch.

The control unit may generate a control signal to control the carriage to have a motion amplitude of no more than five times a single nozzle pitch.

N may be equal to 2.

The control unit may generate a control signal to transfer the print medium at a “1/n” speed with respect to a print medium transferring speed of a normal printing mode.

The foregoing and/or other aspects of the present general inventive concept are also achieved by providing an image forming apparatus, including a printhead having a length that corresponds to at least a width of a print medium and a predetermined nozzle pitch, and a control unit to control the printhead to move back and forth with a motion range of at least two times the predetermined nozzle pitch.

The foregoing and/or other aspects of the present general inventive concept are also achieved by providing an image forming apparatus, including a printhead having a plurality of nozzles extending along at least a width of a print medium, and a control unit to control the printhead to move back and forth with respect to an initial position with a motion amplitude of between one nozzle pitch and five nozzle pitches to perform a plurality of ink ejection operations to form a single pixel line.

The foregoing and/or other aspects of the present general inventive concept are also achieved by providing an image forming apparatus including a printhead having a plurality of nozzles extending along at least a width of a print medium and a predetermined nozzle pitch, and a control unit to control the printhead to eject ink and to move the printhead from an initial position thereof with a motion amplitude that is a multiple of the predetermined nozzle pitch of the printhead in a plurality of steps that are a fraction of the predetermined nozzle pitch of the printhead.

The foregoing and/or other aspects of the present general inventive concept are also achieved by providing an image forming apparatus including a printhead having a plurality of nozzles extending along at least a width of a print medium, and a control unit to control the printhead to print at an initial position, to reciprocate with a motion amplitude with respect to the initial position such that the printhead ejects ink to compensate for a malfunctioning nozzle when the printhead is being moved from the initial position toward a maximum motion amplitude position and the printhead ejects ink to increase a resolution of the initial position print while the printhead is being moved back from the maximum motion amplitude position toward the initial position.

The foregoing and/or other aspects of the present general inventive concept are also achieved by providing an image forming apparatus including a printhead having a plurality of nozzles extending along at least a width of a print medium, and a control unit to control the printhead to print at an initial position such that a plurality of initial ink dots are ejected to the print medium and to reciprocate the printhead with respect to the initial position in first and second directions such that the control unit controls the printhead to perform a malfunctioning nozzle compensation operation when the printhead is moved in the first direction and the control unit controls the printhead to perform a high resolution print operation between the initial ink dots when the printhead is moved in the second direction.

The foregoing and/or other aspects of the present general inventive concept are also achieved by providing an image forming apparatus including a printhead having a width that extends along at least a width of a print medium and having an actual resolution, and a control unit to operate the printhead between a normal printing mode in which a printing resolution is equal to the actual resolution, a high resolution mode in which the printhead is reciprocated with respect to an initial printing position while ink is ejected between initial ink dots such that the printing resolution is greater than the actual resolution, a compensation printing mode in which the printhead is reciprocated with respect to the initial printing position while a selected functioning nozzle prints to a position on the print medium that corresponds to a malfunctioning nozzle, and a high resolution compensation mode in which the printhead is reciprocated with respect to the initial printing position while ink is ejected between the initial ink dots such that the printing resolution is greater than the actual resolution and the selected functioning nozzle prints to the position on the print medium that corresponds to the malfunctioning nozzle.

The foregoing and/or other aspects of the present general inventive concept are also achieved by providing a high resolution printing method for an inkjet image forming apparatus having a printhead, which has a nozzle unit with a length that corresponds to at least a width of a print medium, and is reciprocally moved for printing, the method including receiving a desired resolution for printing from a host, comparing the desired resolution and an actual resolution of the printhead, printing an image that corresponds to a first portion of a single pixel line by ejecting ink onto the print medium, moving the printhead in a longitudinal stepwise manner by a magnitude of “D/N” for “n” times with a motion amplitude in a range of more than a single nozzle pitch to the length of the nozzle unit, when the desired resolution is greater than the actual resolution of the printhead, and printing an image that corresponds to a second portion of the single pixel line by ejecting ink onto each position corresponding to a distance of “D/N” between adjacent nozzles in the printhead, where “D” is a nozzle pitch, “n” is a predetermined natural number, and “N” is a ratio of the desired printing resolution to the actual resolution of the printhead.

The printing of the image that corresponds to the second portion of the single pixel line by ejecting ink onto each position that corresponds to the distance D/N between the adjacent nozzles may include ejecting ink for printing each time after the printhead moves by more than a single nozzle pitch when printing with high resolution.

The method may further include detecting whether a malfunctioning nozzle exists in the nozzle unit, storing information about the detected malfunctioning nozzle in a memory, and compensating for the malfunctioning nozzle by ejecting ink from a nozzle moved to the position where the malfunctioning nozzle is positioned during a previous ejection according to the information stored in the memory.

Only the nozzle moved to the position where the malfunctioning nozzle is positioned during a previous ejection may be driven.

The printhead may eject ink to compensate for the malfunctioning nozzle before the printhead arrives at a position that corresponds to a maximum motion amplitude when the printhead has moved by a distance larger than a single nozzle pitch.

The moving of the printhead may further include reciprocally moving the printhead within a motion amplitude of no more than five times a single nozzle pitch in either direction with respect to an initial position of the printhead.

The printing may be performed by transferring the print medium at a “1/n” speed with respect to a print medium transferring speed of a normal printing mode.

The foregoing and/or other aspects of the present general inventive concept are also achieved by providing method of controlling an image forming apparatus having a printhead with a plurality of nozzles extending along at least a width of a print medium, the method including controlling the printhead to print to the print medium at an initial position, and controlling the printhead to move by at least one nozzle pitch such that a functioning nozzle that is adjacent to a malfunctioning nozzle prints to a portion of the print medium that corresponds to the malfunctioning nozzle.

The foregoing and/or other aspects of the present general inventive concept are also achieved by providing a method of controlling an image forming apparatus including a printhead having a plurality of nozzles extending along at least a width of a print medium and a predetermined nozzle pitch, the method including controlling the printhead to eject ink at an initial position, and controlling the printhead to move from the initial position with a motion amplitude that is a multiple of the predetermined nozzle pitch of the printhead in a plurality of steps that are a fraction of the predetermined nozzle pitch of the printhead.

The foregoing and/or other aspects of the present general inventive concept are also achieved by providing a method of controlling an image forming apparatus including a printhead having a plurality of nozzles extending along at least a width of a print medium, the method including controlling the printhead to print at an initial position such that a plurality of initial ink dots are ejected to the print medium, and controlling the printhead to reciprocate with respect to the initial position in first and second directions such that the printhead performs a malfunctioning nozzle compensation operation when the printhead is moved in the first direction and performs a high resolution print operation between the initial ink dots when the printhead is moved in the second direction.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a schematic cross-sectional view illustrating an inkjet image forming apparatus according to an embodiment of the present general inventive concept;

FIG. 2 is a plan view illustrating a portion of a printhead of the image forming apparatus of FIG. 1;

FIG. 3 is a perspective view illustrating a carriage moving unit of the image forming apparatus of FIG. 1, according to an embodiment of the present general inventive concept;

FIG. 4 is a perspective view illustrating a carriage moving unit of the image forming apparatus of FIG. 1, according to another embodiment of the present general inventive concept;

FIG. 5 is a perspective view illustrating a carriage moving unit of the image forming apparatus of FIG. 1, according to yet another embodiment of the present general inventive concept;

FIG. 6 is a cross-sectional view illustrating the carriage moving unit of FIG. 5;

FIG. 7 is a block diagram of an image forming system according to an embodiment of the present general inventive concept;

FIG. 8 is a block diagram illustrating an image forming apparatus of the image forming system of FIG. 7, according to an embodiment of the present general inventive concept;

FIG. 9A illustrates a printing pattern when a malfunctioning nozzle is compensated for while a carriage is moving within a single nozzle pitch in both directions with respect to an initial position of the carriage, according to an embodiment of the present general inventive concept;

FIG. 9B illustrates a printing pattern when a malfunctioning nozzle is compensated for while the carriage is moving in one direction within two nozzle pitches with respect to the initial position of the carriage, according to another embodiment of the present general inventive concept;

FIG. 9C illustrates a printing pattern when a malfunctioning nozzle is compensated for while the carriage is reciprocally moving within two nozzle pitches in both directions with respect to the initial position of the carriage, according to another embodiment of the present general inventive concept;

FIG. 10 is a flow chart illustrating a high resolution printing method according to an embodiment of the present general inventive concept;

FIG. 11A illustrates a printing pattern when printing is performed while a printhead is reciprocally moving within a single nozzle pitch in both directions with respect to an initial position of the printhead, according to an embodiment of the present general inventive concept;

FIG. 11B illustrates a printing pattern when printing is performed while the printhead is moving in one direction within two nozzle pitches with respect to the initial position of the printhead, according to an embodiment of the present general inventive concept;

FIG. 11C illustrates a printing pattern when printing is performed while the printhead is reciprocally moving within one and a half nozzle pitch in both directions with respect to the initial position of the printhead, according to an embodiment of the present general inventive concept; and

FIG. 11D illustrates a printing pattern when printing is performed while the printhead is reciprocally moving within two nozzle pitches in both directions with respect to the initial position of the printhead, according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

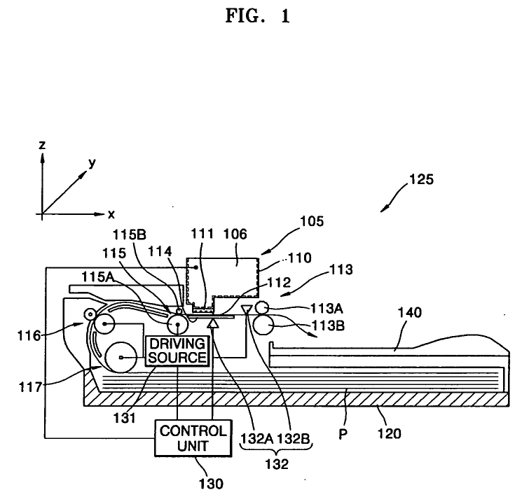

FIG. 1 is a cross-sectional view of an inkjet image forming apparatus 125 according to an embodiment of the present general inventive concept. Referring to FIG. 1, the inkjet image forming apparatus 125 includes a feeding cassette 120, a printhead unit 105, a supporting member 114 opposite to the printhead unit 105, a detecting unit 132 to detect a malfunctioning nozzle, pick-up, auxiliary, feeding and discharging rollers 117, 116, 115, and 113 to transfer a print medium P in a first direction (i.e., an x direction) and a stacking unit 140 on which a discharged print medium P is stacked. In addition, the inkjet image forming apparatus 125 further includes a control unit 130 which will be described later. The printhead unit 105 includes a body 110 mounted in a movable carriage 106, and the body 110 has a printhead 111 disposed on a bottom side thereof.

The print medium P is stacked on the feeding cassette 120. The print medium P is transferred from the feeding cassette 120 under the printhead 111 to the stacking unit 140 by the rollers 117, 116, 115, and 113. The stacking unit 140 is, for example, a discharging paper tray, where the print medium P on which an image is formed are stacked after discharging.

The pick-up roller 117, the auxiliary roller 116, the feeding roller 115, and the discharging roller 113 transfer the print medium P along a predetermined path. The rollers 117, 116, 115 and 113 are driven by a driving source 131, such as a motor, and provide a transferring force to transfer the print medium P. The driving source 131 is controlled by the control unit 130.

The pick-up roller 117 is installed at one side of the feeding cassette 120 and picks up the print medium P stacked in the feeding cassette 120. The feeding roller 115 is installed at an inlet side of the printhead 111 and feeds the print medium P to the printhead 111. The feeding roller 115 includes a driving roller 115A to supply a transferring force to transfer the print medium P, and an idle roller 115B elastically engaged with the driving roller 115A. The auxiliary roller 116 that transfers the print medium P may be further installed between the pick-up roller 117 and the feeding roller 115. The discharging roller 113 is installed at an outlet side of the printhead 111 and discharges the print medium P on which the printing has been completed, out of the image forming apparatus 125. The discharged print medium P is stacked on the stacking unit 140.

The discharging roller 113 includes a star wheel 113A installed along a widthwise direction of the print medium P, and a supporting roller 113B opposite to the star wheel 113A to support a rear side of the print medium P. The print medium P may wrinkle due to ink ejected onto a top side of the print medium P while passing through a nozzle unit 112 disposed on the printhead 111. The distance between the print medium P and the nozzle unit 112 may be changed due to the wrinkles of the print medium P The star wheel 113A prevents the print medium P that is fed underneath the nozzle unit 112 from contacting a bottom surface of the nozzle unit 112 and/or the body 110, and prevents the distance between the print medium P and the bottom surface of the nozzle unit 112 and/or the body 110 from being changed. The star wheel 113A is installed such that at least a portion of the star wheel 113A protrudes from the nozzle unit 112, and contacts at a point of a top surface of the print medium P.

The supporting member 114 is installed below the printhead 111 and supports the rear side of the print medium P to maintain the predetermined distance between the nozzle unit 112 and the print medium P. The distance between the nozzle unit 112 and the print medium P may be about 0.5-2.5 mm.

The detecting unit 132 detects the malfunctioning nozzle of the nozzle unit 112 formed on the printhead 111. The malfunctioning nozzle is a nozzle that improperly ejects ink or a nozzle that fails to eject ink. That is, the malfunctioning nozzle exists when ink is not ejected from a nozzle due to several causes or when a smaller amount of ink is ejected. The malfunctioning nozzle may be produced in a process of manufacturing the printhead 111, or during printing. In general, information about the malfunctioning nozzle produced in the manufacturing process is stored in a memory (not shown) installed in the printhead 111 and may be transmitted to the image forming apparatus 125 when the printhead 111 is mounted in the image forming apparatus 125.

In general, a printhead of an inkjet image forming apparatus may be classified as one of two types of printheads according to an actuator that provides an ejecting force to ink droplets. The first type is a thermal driving printhead that generates bubbles in ink using a heater, thereby ejecting the ink droplets due to an expanding force of the bubbles. The second type is a piezoelectric driving printhead that ejects the ink droplets using a pressure applied to the ink due to a deformation of a piezoelectric device. If ink is ejected using the thermal driving, the malfunctioning nozzle can be easily detected when (1) the heater used to eject the ink is disconnected, (2) a driving circuit of the heater is broken, or (3) nozzle malfunctions occur as a result of an electrical element such as a field effect transistor FET. Likewise, when the ink is ejected using the piezoelectric driving method, defects of the piezoelectric device or malfunctions of nozzles that occur as a result of damages of a driving circuit to drive the piezoelectric device can be easily detected.

On the other hand, the causes of a malfunctioning nozzle may not be easily detected when the nozzle is clogged with foreign material. When the causes of a malfunctioning nozzle cannot be easily detected, a test page printing is performed. If a malfunctioning nozzle exists in the nozzle unit 112, a print concentration of a portion of the print medium P printed by the malfunctioning nozzle is lower than a portion of the print medium P printed by a normal nozzle due to missing ink dots. The portion of the print medium P printed with lower concentration is detected by the second detecting unit 132B. Accordingly, the malfunctioning nozzle generated during printing can be detected using the second detecting unit 132B.

The detecting unit 132 includes the first detecting unit 132A and the second detecting unit 132B. The first detecting unit 132A detects whether nozzles are clogged by radiating light directly onto the nozzle unit 112, and the second detecting unit 132B detects whether a malfunctioning nozzle exists in the nozzle unit 112 by radiating light onto the print medium P when the print medium P is transferred.

Alternatively, the existence of a malfunctioning nozzle can be automatically detected via nozzle inspection signals respectively transmitted to nozzles in the printhead 111. The method of detecting a malfunctioning nozzle should be known to those of skill in the art, and thus a detailed description thereof will not be provided here. A variety of apparatuses and methods can be employed to detect whether a malfunctioning nozzle exists.

The detecting unit 132 includes an optical sensor. The optical sensor includes a light-emitting part (not shown) such as a light emitting diode that radiates light onto the print medium P and a light-receiving sensor (not shown) that receives light reflected from the print medium P. An output signal from the light-receiving sensor is input to the second detecting unit 132B. The second detecting unit 132B detects whether a malfunctioning nozzle exists in the nozzle unit 112 in response to the output signal, and information about whether the malfunctioning nozzle exists in the nozzle unit 112 is transmitted to the control unit 130. The light emitting part and the light receiving sensor can be formed as a one-body type (i.e., integrally) or formed as several separate units. Structures and operations of the optical sensor should be known to those of skill in the art, and thus a detailed description thereof will not be provided here.

The detecting unit 132 detects whether the malfunctioning nozzle exists in the nozzle unit 112 using the above-described operations. The information about the malfunctioning nozzle detected by the detecting unit 132 is stored in a memory (not shown) and the control unit 130 controls the operation of each component of the image forming apparatus 125 according to the information about the malfunctioning nozzle stored in the memory. The memory may be a nozzle memory.

The printhead unit 105 prints an image by ejecting ink onto the print medium P, and includes the body 110, the printhead 111 installed on one side of the body 110, the nozzle unit 112 formed on the printhead 111, and the carriage 106 on which the body 110 is mounted. The body 110 is mounted on the carriage 106 in a cartridge type manner and the carriage 106 is movably installed along the second direction (i.e., a y direction) which is a longitudinal direction of the printhead 111, on a carriage moving unit 160 which will be described later. The feeding roller 115 is rotatably installed at an inlet side of the nozzle unit 112, and the discharging roller 113 is rotatably installed at the outlet side of the nozzle unit 112.

Although not illustrated, a removable cartridge type ink container is provided in the body 110. Further, the body 110 may include chambers, each of which has ejecting units (for example, piezoelectric elements or heat-driving type heaters) that are connected to respective nozzles of the nozzle units 112 and provide pressure to eject the ink, a passage (for example, an orifice) to supply the ink contained in the body 110 to each chamber, a manifold that is a common passage to supply the ink that flows through the passage to the chamber, and a restrictor that is an individual passage to supply the ink from the manifold to each chamber. The chamber, the ejecting unit, the passage, the manifold, and the restrictor should be known to a person skilled in the art, and thus detailed descriptions thereof will not be provided here. In addition, the ink container (not shown) may be separately installed from the printhead unit 105. The ink stored in the ink container (not shown) may be supplied to the printhead unit 105 through a supplying unit such as a hose.

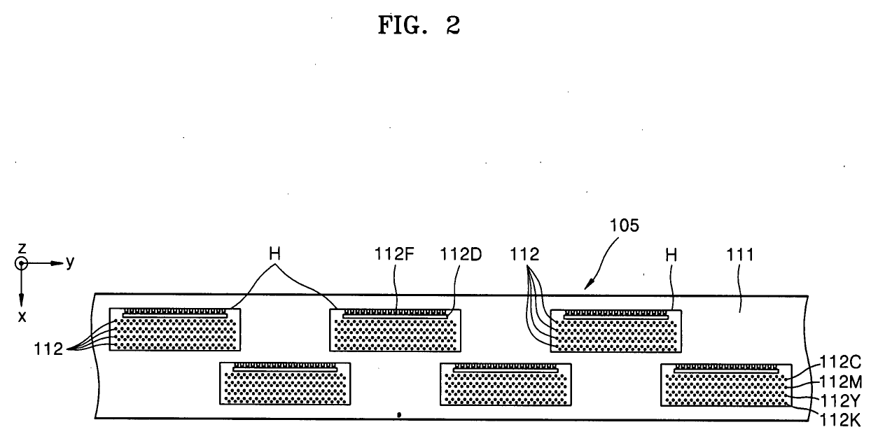

FIG. 2 is a plan view illustrating a portion of the printhead 111 of FIG. 1. Referring to FIGS. 1 and 2, the printhead 111 is installed along the second direction (i.e., the y direction) with respect to the print medium P that is transferred along the first direction, (i.e., the x direction). The printhead 111 uses heat energy or the piezoelectric device as an ink ejecting force, and is made to have a high resolution (i.e. actual resolution) through a semiconductor manufacturing process including, for example, etching, deposition, and/or sputtering. The printhead 111 includes the nozzle unit 112 to eject ink onto the print medium P to form an image. The nozzle unit 112 has a length that is greater than or equal to the width of print medium P. The nozzle unit 112 is reciprocally moved along the second direction, (i.e., the y direction) by the carriage moving unit 160.

As illustrated in FIG. 2, a plurality of head chips H having a plurality of nozzle arrays 112C, 112M, 112Y, and 112K may be installed on the printhead 111. Each of the head chips H has a driving circuit 112D that drives nozzles selectively or in units of a group of nozzles. Each of the head chips H may be formed of a single chip having a length that is equal to that of the printhead 111 (i.e., width of the print medium P). When the printhead 111 is formed as the single chip, an entire printhead 111 should be replaced when some nozzles malfunction, thereby increasing maintenance cost. Accordingly, the plurality of head chips H may be longitudinally arranged, as illustrated in FIG. 2. In addition, when the plurality of the head chips H are arranged in a single line, a distance between the head chips H may become greater than a distance between the nozzles in the same head chips H, thereby generating an unprinted portion. Therefore, the plurality of the head chips H may be arranged in a zigzag shape. Some of the nozzle arrays 112C, 112M, 112Y, and 112K in the head chip H, which eject ink of the same color may be disposed to overlap with respect to one another along the first direction (i.e., the x direction) to enhance printing resolution in the second direction (i.e., the y direction). In this case, ink dots ejected by the nozzles in the nozzle arrays 112, 112M, 112Y and 112K are deposited on positions between ink dots ejected by the nozzles in the other nozzle arrays, thereby enhancing the printing resolution in the second direction (i.e., the y direction). The printhead 111 having the nozzle unit 112 of the plurality of the head chips H of the present embodiment is intended to be exemplary, and it should be understood that the nozzle unit 112 may have various other shapes. Although two nozzle arrays that eject ink of the same color overlap with respect to each other in the embodiment of FIG. 2, one nozzle array may alternatively be arranged along the second direction. Therefore, the nozzle unit 112 illustrated in FIG. 2 should not limit the scope of the present general inventive concept.

Each of the nozzles in the nozzle unit 112 includes the driving circuit 11 2D and a cable 112F to receive printing data, electric power, control signals, etc. The cable 112F may be a flexible printed circuit (FPC) or a flexible flat cable (FFC).

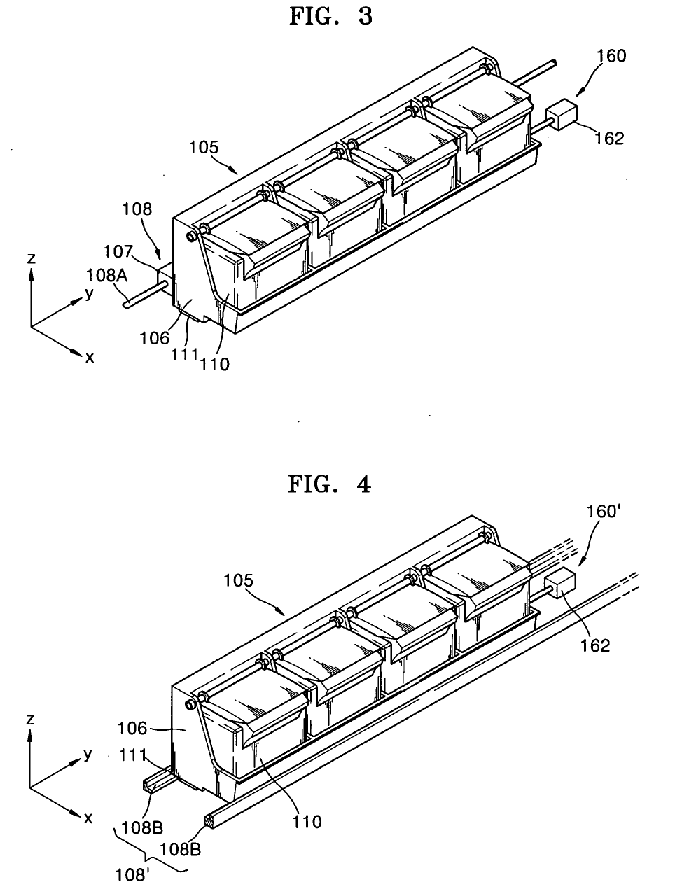

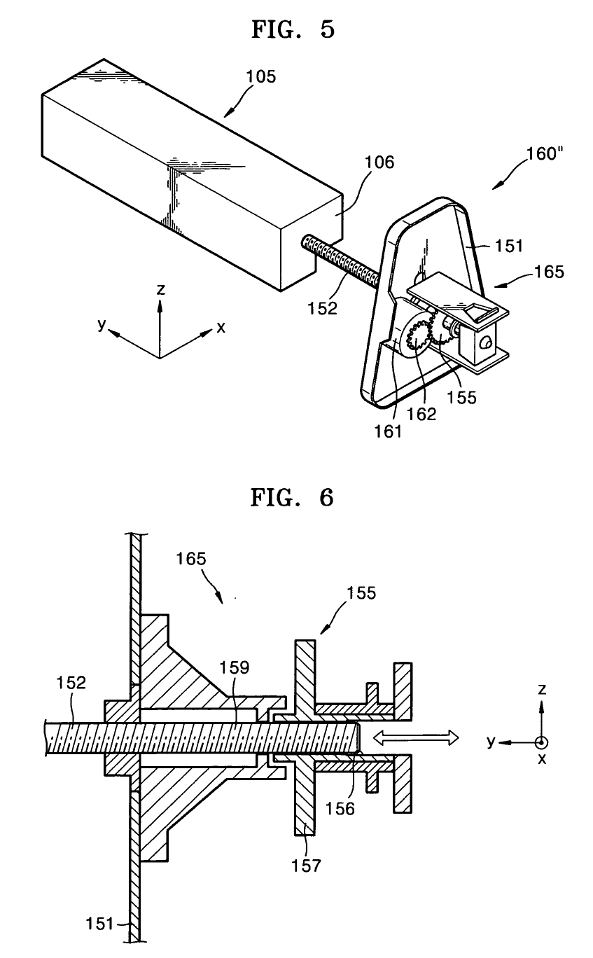

FIG. 3 is a perspective view illustrating the carriage moving unit 160 according to an embodiment of the present general inventive concept. FIG. 4 is a perspective view illustrating the carriage moving unit 160′ according to another embodiment of the present general inventive concept. FIG. 5 is a perspective view illustrating the carriage moving unit 160″ according to yet another embodiment of the present general inventive concept. FIG. 6 is a cross-sectional view of the carriage moving unit 160″ of FIG. 5.

Referring to FIGS. 2 through 4, the carriage 106 is movably installed along the second direction (i.e., the y direction), in which the printhead 111 is mounted. The carriage moving unit 160 or 160′ reciprocally moves the carriage 106 in the second direction (i.e., the y direction), which is a longitudinal direction of the printhead 111. When compensating for a malfunctioning nozzle or printing with high resolution, the carriage moving unit 160 or 160′ moves the carriage 106 “n” steps with a predetermined uniform motion amplitude. For example, the carriage moving unit 160 or 160′ may be moved “n” times by a predetermined factor of a nozzle pitch. The operation of the carriage moving unit 160 or 160′ is controlled by the control unit 130.

The carriage moving unit 160 or 160′ includes a driving unit 162 reciprocally moving the carriage 106 along the second direction (i.e., the y direction). A piezoelectric device used to drive a device such as an optical mirror can be used as the driving unit 162. The piezoelectric device driven by an electric voltage has a positional accuracy of several μm and a high frequency response characteristic. Accordingly, when a piezoelectric device is used in the driving unit 162, the position of the carriage 106 can be accurately controlled. In the present embodiment, the reciprocal movement of the carriage 106 using the piezoelectric device is described as an example, however, it should be understood that this description is not intended to limit the scope of the present general inventive concept.

The carriage moving unit 160 or 160′ may further include a guide unit 108 or 108′ to guide the reciprocal motion of the carriage 106. As illustrated in FIG. 3, the guide unit 108 includes a combining unit 107 and a guide shaft 108A. The combining unit 107 is perforated at one side of the carriage 106. The guide shaft 108 is installed in the main frame (not shown) and inserted into the combining unit 107 formed as a hollow shape and guides the reciprocating motion of the carriage 106. That is, the carriage 106 is installed to slide with respect to the guide shaft 108A. As illustrated in FIG. 4, the guide unit 108′ may include guide rails 108B. The guide rails 108B are installed at one or both sides of the carriage 106 and guide the reciprocal motion of the carriage 106.

Referring to FIGS. 5 and 6, the carriage moving unit 160″ is connected to the carriage 106 and includes a guide rod 152 extending along the second direction (i.e., y direction), and a reciprocal driving unit 165 which reciprocally moves the guide rod 152 along the second direction (i.e., the y direction). A lead screw 159 meshing with a female gear of the connection gear 155, which will be described later, is formed on an outer circumference of the guide rod 152. The reciprocal driving unit 165 includes a frame 151 fixed in the image forming apparatus 125, the connection gear 155 having an inner circumference 156 that has a female gear meshing with the gear of the lead screw 159, and an outer circumference 157 of the connection gear 155 has gear teeth. A driving motor 161 that drives the connection gear 155 is fixed at the frame 151. The driving motor 161 includes a gear 162 meshing with and transmitting a driving force to the connection gear 155. When the gear 162 driven by the driving motor 161 rotates in forward or reverse directions, the connection gear 155 meshing with the gear 162 rotates to transmit the driving force to the lead screw 159 meshing with the inner circumference 156 of the connection gear 155, and thus the guide rod 152 is reciprocally moved along the second direction (i.e., the y direction). The carriage 106 connected to the guide rod 152 is also moved along the second direction (i.e., the y direction).

A pulse motor or a step motor may be used in the carriage moving unit 160, 160′, or 160″. A moving distance of the carriage 106 may be controlled by the motor and/or an encoder sensor.

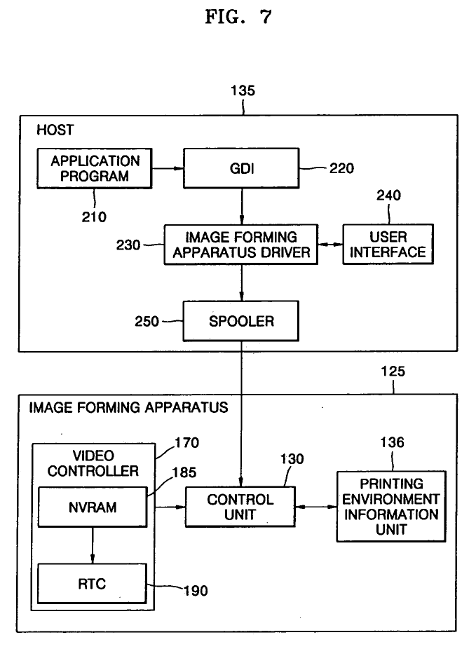

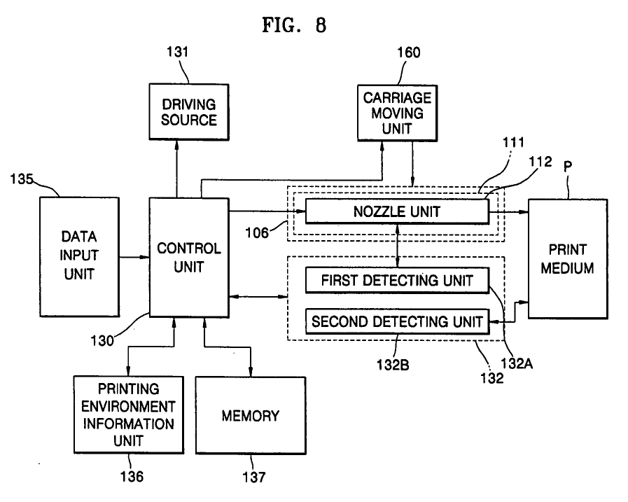

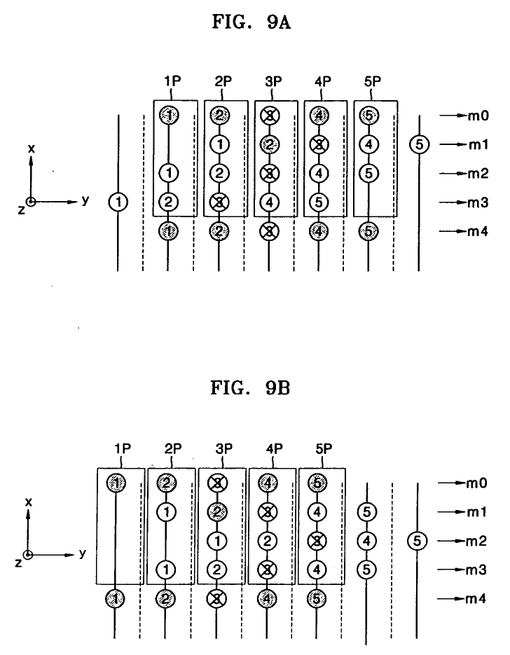

FIG. 7 is a block diagram of an image forming system according to an embodiment of the present general inventive concept. FIG. 8 is a block diagram illustrating an image forming apparatus 125 of the image forming system of FIG. 7, according to an embodiment of the present general inventive concept. The image forming apparatus 125 of FIG. 8 may be similar to the image forming apparatus of 125 of FIG. 1. Accordingly, the image forming system of FIG. 7 and the image forming apparatus of 125 of FIG. 8 are described below with reference to FIGS. 1 to 8. Here, the image forming system includes a data input unit 135 (i.e., a host) and the inkjet image forming apparatus 125.

Referring to FIG. 7, the data input unit 135 is a host system such as a personal computer (PC), a digital camera, or a personal digital assistant (PDA) and receives image data of pages to be printed. The data input unit 135 includes an application program 210, a graphics device interface (GDI) 220, an image forming apparatus driver 230, a user interface 240, and a spooler 250.

The application program 210 generates and edits an object that can be printed by the image forming apparatus 125. The GDI 220, which is a program installed in the host, receives the object from the application program 210, provides the object to the image forming apparatus driver 230, and generates commands related to the object in response to a request from the image forming apparatus driver 230. The image forming apparatus driver 230 is a program installed in the host to generate printer commands that can be interpreted by the image forming apparatus 125. The user interface 240 for the image forming apparatus driver 230 is a program installed in the host that provides environment variables with which the image forming apparatus driver 230 generates the printer commands. A user can select a printing mode, for example, a draft printing mode, a normal printing mode, and a high resolution printing mode, through the user interface 240. The spooler 250 is a program installed in an operating system of the host and transmits the printer commands generated by the image forming apparatus driver 230 to an input/output device (not shown) of the image forming apparatus 125.

The inkjet image forming apparatus 125 includes a video controller 170, a control unit 130,and a printing environment information unit 136. The video controller 170 may include a non-volatile random access memory (NVRAM) 185, a static random access memory (SRAM, not shown), a synchronous dynamic random access memory (SDRAM, not shown), a NOR Flash (not shown), and a real time clock (RTC) 190. The video controller 170 interprets the printer commands generated by the image forming apparatus driver 230 to convert the printer commands into corresponding bitmaps and transmits the bitmaps to the control unit 130. The control unit 130 transmits the bitmaps to each component of the image forming apparatus 125 to print an image on the print medium P.

Referring to FIG. 8, the control unit 130 is mounted on a motherboard (not shown) of the image forming apparatus 125, and controls an ejecting operation of the nozzle unit 112 installed in the printhead 111, transferring operations of the rollers 113, 115, 116, and 117, and an operation of the carriage moving unit 160, 160′, or 160″. That is, the control unit 130 synchronizes the operation of each component so that the ink ejected from the nozzle unit 112 can be deposited on desired areas of the print medium P, when the detecting unit 132 detects a malfunctioning nozzle and/or when the printing operation is performed with high resolution. In addition, the control unit 130 stores image data input through the data input unit 135 in a memory 137, and confirms whether the image data to be printed is completely stored in the memory 137.

The printing environment information unit 136 stores a plurality of printing environment information corresponding to each printing environment when the image data is input from the application program 210 in a predetermined printing environment. That is, the printing environment information unit 136 stores a plurality of types of printing environment information that correspond to each type of printing environment input from the user interface 240. Here, the printing environment includes at least one of a printing density, a resolution, a size of a print medium, a type of a print medium, a temperature, a humidity, and a continuous printing function. The control unit 130 controls the operations of the printhead 111, the carriage moving unit 160,160′, or 160″ and the rollers 113, 115, 116, and 117 in each printing environment stored in the printing environment information unit 136 that corresponds to the input printing environment.

Hereinafter, the operation of the inkjet image forming apparatus 125 that compensates for a malfunctioning nozzle will be described.

Referring to FIGS. 1 to 8, the control unit 130 controls the nozzle unit 112 mounted in the printhead 111 to eject ink onto the print medium P, thereby printing an image corresponding to a single pixel line. The control unit 130 can also control the nozzle unit 112 to print an image to correspond to a single pixel. When a malfunctioning nozzle is detected, the control unit 130 controls the carriage moving unit 160, 160′, or 160″ to move the carriage 106 by a magnitude of a nozzle pitch (or a predetermined factor of the nozzle pitch) “n” times in a stepwise manner. Here, the control unit 130 may reciprocally move the carriage 106 while varying a motion amplitude in the range between more than a single nozzle pitch to a length of the nozzle unit 112. Thus, the motion amplitude may be at least one nozzle pitch on each side of an initial position of the printhead 111 and at least two nozzle pitches on one side of the initial position of the printhead 111. Here the nozzle pitch indicates the distance between two adjacent nozzles. The nozzle pitch defines the actual resolution of the printhead 111. The control unit 130 moves the carriage 106 in this manner and controls each component of the inkjet image forming apparatus 125 so as to compensate for the malfunctioning nozzle by ejecting ink from an adjacent nozzle when the adjacent nozzle is moved to the position where the malfunctioning nozzle is positioned for a previous ejection. In other words, the control unit 130 moves a functioning nozzle that is adjacent to the malfunctioning nozzle to a position that corresponds to the malfunctioning nozzle, thereby ejecting ink to compensate for the malfunctioning nozzle. Here, the control unit 130 may control the operations of the rollers 113, 115, 116, and 117 so as to compensate for missing dots caused by a malfunctioning nozzle while moving the carriage 106 “n” times. For example, the control unit 130 controls the operation of the rollers 113, 115, 116, and 117 such that the print medium P is transferred at “1/n” times a transferring speed of the normal printing mode.

As described above, when printing an image that corresponds to a single pixel line when a malfunctioning nozzle is detected, the control unit 130 may move the carriage 106 while varying the motion amplitude in the range of (1) more than a single nozzle pitch and (2) the length of the nozzle unit 112 “n” times in a stepwise manner, and control the operation of each component so as to compensate for a malfunctioning nozzle using an ink ejection from an adjacent nozzle (i.e., a functioning nozzle) when the adjacent nozzle is moved to the position where the malfunctioning nozzle is positioned for the previous ejection (i.e., the position that corresponds to the malfunctioning nozzle).

The control unit 130 generates a control signal to control the carriage moving unit 160, 160′, and 160″ and the printhead 111 to eject ink for compensation before the carriage arrives at a position that corresponds to a maximum motion amplitude. Here, the control unit 130 may control the operation of the printhead 111 so as to operate only a nozzle moved to the position where the malfunctioning nozzle is positioned for the previous ejection. In addition, the control unit 130 may control the operation of the carriage moving unit 160, 160′, or 160″ such that the carriage 106 has a motion amplitude less than or equal to five times the single nozzle pitch. That is, the control unit 130 may control the carriage moving unit 160, 160′, or 160″ so as to reciprocally move the carriage 106 within five nozzle pitches on each side of an initial position of the carriage 106 (i.e., ten total nozzle pitches).

Hereinafter, the operations of the control unit 130 and the printhead 111 to compensate for a malfunctioning nozzle will be described in detail with reference to the accompanying drawings.

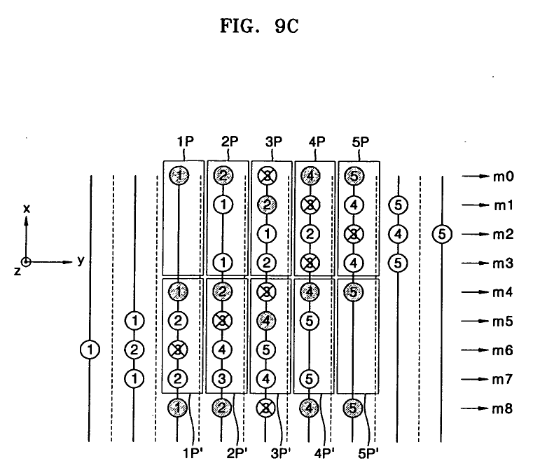

FIGS. 9A through 9C illustrate printing patterns when compensating for a malfunctioning nozzle. FIG. 9A illustrates a printing pattern when a malfunctioning nozzle is compensated for while the carriage 106 is reciprocally moved within a single nozzle pitch in either and/or both directions with respect to the initial position of the carriage 106. FIG. 9B illustrates a printing pattern when a malfunctioning nozzle is compensated for while the carriage 106 is moved in one direction within two nozzle pitches in either and/or both directions with respect to the initial position of the carriage 106. FIG. 9C illustrates a printing pattern when a malfunctioning nozzle is compensated for while the carriage 106 is reciprocally moved within two nozzle pitches in either and/or both directions with respect to the initial position of the carriage 106. In the drawings, reference numerals 1, 2, 3, 4, and 5 indicate ink dots ejected from the nozzles, reference numerals 1P, 2P, 3P, 4P, and 5P indicate pixels printed by each of the nozzles, respectively, and the reference numerals m0 through m8 indicate the positions of the printhead 111 during the reciprocal motion. Hereinafter, an example in which a nozzle 3 (hereinafter“nozzle No. 3”) is a malfunctioning nozzle will be described.

Referring to FIG. 9A, the printhead 111 ejects ink at an initial position m0 thereof to print data that corresponds to a single pixel line. Here, since the nozzle No. 3 does not eject ink (i.e., nozzle No. 3 is the malfunctioning nozzle), ink is not deposited on the pixel 3P. If this pixel is not compensated for, a white line may appear along the transferring direction of the print medium R To prevent this image degradation, the control unit 130 moves the carriage 106 on which the printhead 111 is mounted by a magnitude equal to the nozzle pitch (m1→m2→m3→m4 illustrated in FIG. 9A) in both directions in a stepwise manner. In FIG. 9A, when the printhead 111 moves by the single nozzle pitch to the right of the initial position m0 of the printhead 111 (i.e., from m0 to m1), a nozzle No. 2 of the printhead 111 is moved to the position that corresponds to the malfunctioning nozzle (i.e., where the nozzle No. 3 is positioned during the previous ejection). Here, if only the nozzle No. 2 is driven to eject ink, ink is deposited on the pixel 3P, which is not initially printed to by the nozzle No. 3, thereby compensating for the malfunctioning nozzle. The printhead 111 is then returned to the initial position through a predetermined path for printing to the next pixel line, shown in the line m4. In particular, he printhead 111 may be moved to the left of the initial position (m1→m2→m3), before being moved back to the initial position (m3→m4) to print to the next pixel line. As described above, the method compensates for a malfunctioning nozzle using a nozzle moved to the position where the malfunctioning nozzle is positioned by moving the printhead 111 several times.

In order to print the next pixel line after ejecting an ink droplet, a recovery time for regenerating a vanished ink meniscus may be necessary. The ink used to compensate for the malfunctioning nozzle may be ejected before the carriage 106 arrives at the position that corresponds to the maximum motion amplitude after the recovery time for regenerating of the ink meniscus. However, if the carriage 106 is reciprocally moved within a single nozzle pitch of both directions, a magnitude of the single nozzle pitch becomes the maximum motion amplitude. Therefore, as illustrated in FIG. 9A, the malfunctioning nozzle may be exceptionally compensated for at the maximum motion amplitude.

Similarly, the compensation of malfunctioning nozzles in the embodiments illustrated in FIGS. 9B and 9C can be performed using similar operations as illustrated in the method of FIG. 9A. However, referring to FIG. 9C, the position of the carriage 106 is changed three times (m1→m2→m3→m4) until the carriage 106 returns to the initial position m4 after compensating for a malfunctioning nozzle at the position m1. That is, there is enough recovery time to regenerate the ink meniscus before the carriage 106 returns to the initial position thereof after compensating for a malfunctioning nozzle. Accordingly, in this case, the printhead 111 may eject ink at the position m4 to print data that corresponds to next pixels 1P′, 2P′, 3P′, 4P′, and 5P′ of the next pixel line. Although the embodiments of FIGS. 9A to 9C illustrate that the printhead 111 is moved in the “n” steps of the single nozzle pitch having different motion amplitudes, it should be understood that the printhead 111 may be moved in the “n” steps of more than one nozzle pitch (e.g., two nozzle pitches).

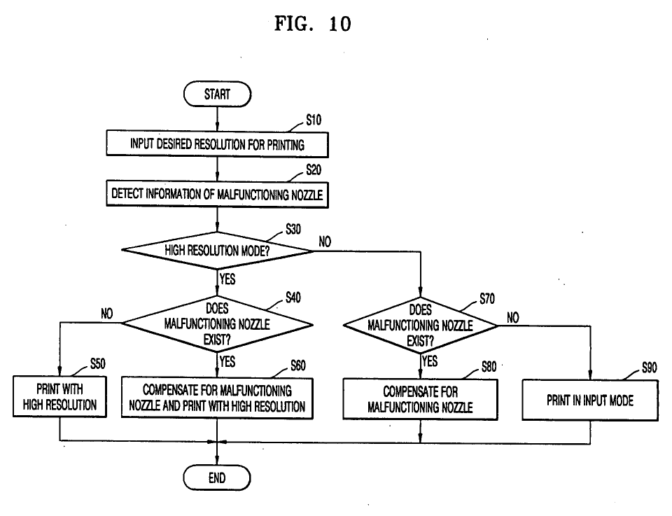

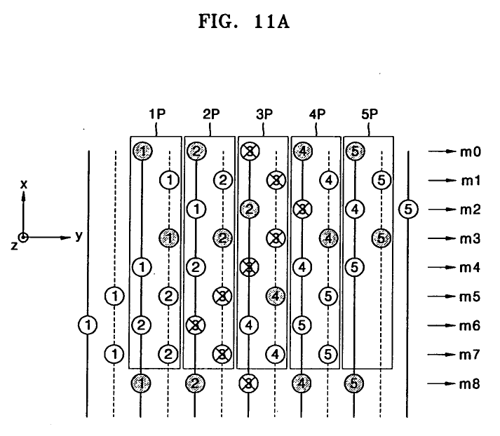

In general, the horizontal resolution (i.e., the actual resolution) of the inkjet image forming apparatus 125 having the printhead 111 with a length that corresponds to the width of a print medium P is physically determined by the distance between nozzles (i.e., a nozzle pitch). In addition, a vertical resolution in the print medium transferring direction is determined by the transfering speed of the print medium P Hereinafter, the operation of the control unit 130 for printing with the high resolution will be described in detail in conjunction with a flow chart of FIG. 10, which illustrates a method of printing with the high resolution and compensating for malfunctioning nozzles. Since the method of FIG. 10 may be performed by the image forming apparatus 125 of FIG. 1, 7, and 8, the method of FIG. 10 is described below with reference to FIGS. 1 to 10.

FIG. 10 is a flow chart illustrating a high resolution printing method according to an embodiment of the present general inventive concept. Referring to FIGS. 1, 7, 8, and 10, a desired resolution for printing is input from the user interface 240 in operation S10. For example, a user can select a printing mode, such as the draft printing mode, the normal printing mode, or the high resolution printing mode, through the user interface 240. As described above, information about the malfunctioning nozzle is detected by the detecting unit 132, stored in a memory (not shown) in operation S20, and then transmitted to the control unit 130.

The control unit 130 compares the desired resolution input from the host (or the data input unit 135) and the actual resolution of the printhead 111 in operation S30 and determines that the printing process should be varied according to the printing resolution and the existence of a malfunctioning nozzle.

If the printing is not to be performed in the high resolution printing mode, an operation of detecting a malfunctioning nozzle is performed in operation S70 such that the malfunctioning nozzle (i.e., if the malfunctioning nozzle exists) is compensated for during the printing in operation S80, or the printing is performed with a printing mode that corresponds to the input resolution in operation S90. The printing process that does not use the high resolution printing mode is described above in the embodiment illustrated in FIGS. 9A through 9C, and thus a detailed description thereof will not be provided.

When using the high resolution printing mode, it is determined whether the malfunctioning nozzle is to be compensated for by detecting whether the malfunctioning nozzle exists in operation S40. If the malfunctioning nozzle is determined to exist in the operation S40, the high resolution printing is performed in operation S60 and the malfunctioning nozzle is compensated for during the high resolution printing. If the malfunctioning nozzle is determined not to exist in the operation S40, the high resolution printing is performed normally.

First, the operation of printing with the high resolution in the operation S50 without compensating for a malfunctioning nozzle will be described in conjunction with the operation of the control unit 130. The control unit 130 controls the nozzle unit 112 mounted in the printhead 111 to eject ink onto the print medium P, thereby printing an image corresponding to a first portion of a single pixel line. After ejecting ink at the initial position as described above, the control unit 130 controls the carriage 106 to move in a stepwise manner to a position where the printhead 111 is mounted by a magnitude of D/N for “n” times and to eject ink onto each position of a D/N interval between two adjacent nozzles (i.e., second portions of the single pixel lines). That is, the printhead 111 is moved “n” times and ink is ejected in a predetermined time-interval, thereby enhancing the printing resolution. Here, “D” indicates a distance between two adjacent nozzles, ( i.e., the nozzle pitch), and “N” indicates a ratio of the desired printing resolution to the actual resolution of the printhead 111. The ink ejections performed at each D/N interval print to the same pixel line as in the initial ink ejection. That is, since these ejections print to ink dots that are adjacent to ink dots in the initial ejection, these ejections can be considered as printing other portions of the single pixel line (e.g., overlapping portions of a pixel line). Here, the control unit 130 controls the printhead 111 to move “n” times and to print an area that corresponds to a single pixel line, such that the resolution is enhanced. Accordingly, the control unit 130 may control the print medium P to move at a “1/n” speed with respect to the print medium transferring speed of the normal printing mode. In addition, the control unit 130 may control the printhead 111 to reciprocally move with a motion amplitude in the range of more than a single nozzle pitch to the length of the nozzle unit 112. As the motion amplitude with which the printhead 111 reciprocally moves is increased, it becomes more difficult for ink dots to be accurately deposited on a desired position because of influence of the acceleration of the printhead 111, a deceleration section, etc. Accordingly, the control unit 130 can move the printhead 111 with a motion amplitude of less than or equal to five times the nozzle pitch. That is, the control unit 130 may control the operation of the carriage moving unit 160, 160′, or 160″ within five nozzle pitches in either and/or both direction (i.e., ten total nozzle pitches) with respect to the initial position of the printhead 111.

The time for regenerating a vanished ink meniscus is necessary to print the next pixel line (or the next portion of the same pixel line) after ejecting an ink droplet. Accordingly, when printing with the high resolution, the control unit 130 may drive the nozzle unit 112 so as to eject ink at each time after the carriage 106 having the printhead 111 moves by more than a single nozzle pitch. That is, when at least one nozzle ejects ink, the control unit 130 may control the next ink to be ejected after the printhead 111 moves by at least more than a single nozzle pitch for regenerating a vanished ink meniscus. As described above, the high resolution printing method according to the present embodiment performs printing by moving the printhead 111 by a magnitude of D/N to eject ink between ink dots on the print medium P for enhancing the printing resolution.

Hereinafter, a printing operation (the operation S60 of the method of FIG.10) will be described when a nozzle malfunctions and printing is performed in the high resolution printing mode.

Referring to FIGS. 1, 7, 8, and 10 the information about the malfunctioning nozzle detected by the detecting unit 132 is transmitted to the control unit 130. As described above, the control unit 130 moves the printhead 111 in a stepwise manner by a magnitude of D/N for “n” times for printing. In other words, the control unit 130 moves to printhead 111 D/N for “n” times to print each pixel line and overlapping portions of the pixel lines in the image. The control unit 130 controls the operation of each component to eject ink to compensate for the malfunctioning nozzle by ink ejection from an adjacent nozzle, when the adjacent nozzle is moved to the position where the malfunctioning nozzle is positioned for the previous ejection. Here, the control unit 130 may control the operation of the rollers 113, 115, 116, and 117 and the carriage 106 such that the carriage 106 is moved “n” times to print missing dots generated by the malfunctioning nozzle during an initial printing operation (i.e., the previous ejection).

The control unit 130 may drive only the adjacent nozzle that is moved to the position that corresponds to the malfunctioning nozzle. Here, the control unit 130 may control the carriage moving unit 160, 160′, or 160″ and the printhead 111 so as to eject ink for compensation before the carriage 106 arrives at a position that corresponds to the maximum motion amplitude when the carriage 106 has moved by a distance that is larger than a single nozzle pitch. In this manner, a sufficient recovery time is allowed to elapse such that the ink is properly prepared (e.g., a meniscus is regenerated) for a next ejection operation form the printhead 111.

The control unit 130 may control the printhead 111 to eject ink for the high resolution printing when the carriage 106 is moved in reverse from the maximum motion amplitude. The malfunctioning nozzle cannot normally eject ink during the ink ejection for the high resolution printing. Accordingly, for the recovery time for the ink meniscus, the control unit 130 may generate a control signal to eject ink for compensating for the malfunctioning nozzle for the high resolution printing after the carriage 106 moves by a distance that is larger than a single nozzle pitch.

As described above, when printing in the high resolution printing mode, an area that corresponds to a single pixel line is printed by moving the printhead 111 “n” times. If the print medium P is transferred at the same speed as when printing in the normal printing mode, the resolution along the horizontal direction or the transferring direction of the print medium P may be degraded. Accordingly, when printing with the high resolution, the control unit 130 may transfer the print medium P slower than the print medium transferring speed of the normal printing mode. The control unit 130 may transfer the print medium P at a “1/n” speed with respect to the print medium transferring speed of the normal printing mode.

Hereinafter, the above-described control unit 130 and the operation of the printhead 111 when printing with the high resolution will be described in detail with reference to the accompanying drawings. For convenience of explanation, an example in which the desired printing resolution is twice as large as the actual resolution of the printhead 111, that is, N is equal to 2, will be described.

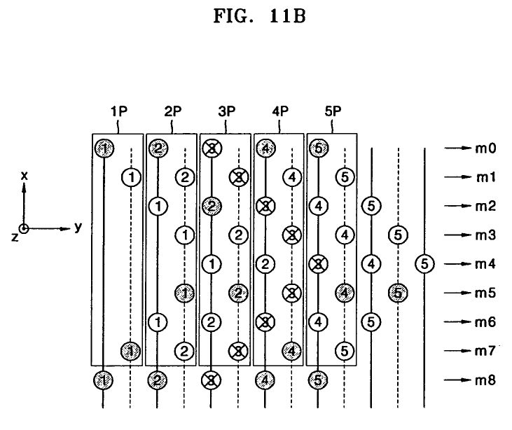

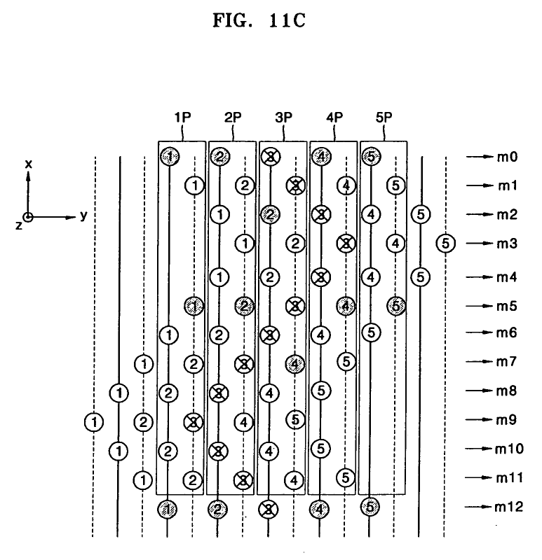

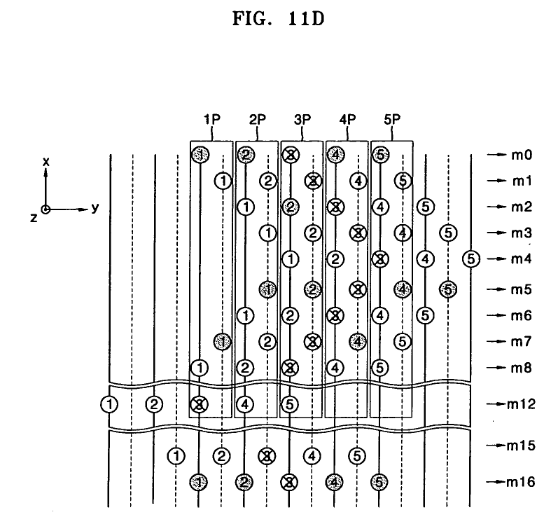

FIGS. 11A through 11D illustrate printing patterns when printing with the high resolution. FIG. 11A illustrates a printing pattern when printing is performed while the printhead 111 is reciprocally moved within a single nozzle pitch in either and/or both directions with respect to the initial position of the printhead 111. FIG. 11B illustrates a printing pattern when printing is performed while the printhead 111 is moved in one direction within two nozzle pitches with respect to the initial position of the printhead 111. FIG. 11C illustrates a printing pattern when printing is performed while the printhead 111 is reciprocally moved within one and half nozzle pitches in either and/or both directions with respect to the initial position of the printhead 111. FIG. 11D illustrates a printing pattern when printing is performed while the printhead 111 is reciprocally moved within two nozzle pitches in either and/or both directions with respect to the initial position of the printhead 111. In the drawings, reference numerals 1, 2, 3, 4, and 5 indicate ink dots ejected from the nozzles, reference numerals 1P, 2P, 3P, 4P, and 5P indicate a single pixel line printed by each of the nozzles, respectively, and the reference numerals m0 through m16 indicate the positions of the printhead 111 during the reciprocal motion. Each single pixel line may include a plurality at overlapped portions that correspond to ink ejections at different positions. Hereinafter, the case in which a nozzle (hereinafter, nozzle No. 3) is a malfunctioning nozzle will be described as an example.

Referring to FIG. 11A, the printhead 111 ejects ink at the initial position m0 to print data that corresponds to a first portion of a single pixel line (i.e., a single ejection line). Here, since the nozzle No. 3 does not eject ink, ink is not deposited on the pixel 3P. In order to compensate for the pixel 3P, the control unit 130 moves the printhead 111 in a stepwise manner by a magnitude of D/2 (i.e., half the nozzle pitch), thereby compensating for the malfunctioning nozzle. In FIG. 11A, when the printhead 111 is moved twice to the right of the initial position m0 of the printhead 111, a nozzle No. 2 of the printhead 111 is positioned at the position that corresponds to the nozzle No. 3 (i.e., the malfunctioning nozzle). Here, if only the nozzle No. 2 is driven to eject ink, ink is deposited on the pixel 3P, which is not initially printed to by the nozzle No. 3, thereby compensating for the malfunctioning nozzle. Then, the printhead 111 is moved again for a next high resolution printing operation to print a next portion of the single pixel line. When the printhead 111 is moved to the position m3, the printhead 111 can eject ink between adjacent ink dots that are initially ejected. Therefore, the resolution along the widthwise direction of the print medium P can be enhanced. In addition, since the print medium P is transferred at a constant speed, a time interval between the initial printing and the high resolution printing exists. Accordingly, since ink dots are deposited on the print medium P having a predetermined distance along the widthwise direction of the print medium P, the resolution in the widthwise direction of the print medium P can be enhanced. However, since the malfunctioning nozzle cannot normally eject ink during the high resolution printing, the malfunctioning nozzle should be compensated for using the compensating method during the initial printing.

During the high resolution printing, ink is initially ejected, and then ink for the high resolution printing is additionally ejected between ink dots that are initially ejected. If ink is continually ejected, the ink meniscus is vibrated by the ejection of a nozzle, thereby degrading the printing quality. That is, when printing with the high resolution, a single pixel line is formed by ejecting ink several times, and the recovery time for the ink meniscus is necessary for printing the next pixel line after ejecting an ink droplet.

As illustrated in FIGS. 11B to 11D, the control unit 130 may control the ink ejection for the compensation before the carriage where the printhead 111 is mounted arrives at a position that corresponds to the maximum motion amplitude to regenerate the vanished ink meniscus. That is, to reduce cross-talk by regenerating the vanished ink meniscus, the ink ejection to enhance the resolution is performed after the printhead 111 is moved by a magnitude of at least a single nozzle pitch. However, as illustrated in FIG. 11A, the case when the printhead 111 is reciprocally moved by a magnitude of a single pitch in both directions with respect to the initial position of the printhead 111 is an exception, since there is a limit regarding the reciprocal moving times. The meniscus and the cross-talk malfunctioning nozzle should be known to those of skill in the art, and thus a detailed description thereof will not be provided.

As illustrated in FIGS. 11A through 11D, the control unit 130 may control the ink ejection for the compensation before the carriage 106 arrives at a position that corresponds to the maximum motion amplitude so as to regenerate the vanished ink meniscus. However, in the case where the carriage 106 is reciprocally moved by a magnitude of a single nozzle pitch in both directions, the single nozzle pitch corresponds to the maximum motion amplitude. Accordingly, in this case illustrated in FIG. 11, the malfunctioning nozzle may be compensated for at the maximum motion amplitude. The ink for the high resolution printing may be ejected when the carriage 106 is moved in reverse from the maximum motion amplitude. Since the malfunctioning nozzle cannot normally eject ink during the ink ejection to enhance the resolution, when arriving at the position to enhance the resolution, an adjacent nozzle can instead eject ink to compensate for the malfunctioning nozzle.

Similiary, the compensation of malfunctioning nozzles and the operation of the high resolution printing in the embodiments illustrated in FIGS. 11B through 11D can be performed using similar operations as the method of FIG. 11A. However, although the method of FIGS. 11A to 11D are described with reference to five nozzles, it should be understood that these arrangements are exemplary and an actual nozzle unit has a length that corresponds to the width of the print medium P. Accordingly, the ink ejection of the nozzle No. 1 at the position m7 in FIG. 11B and 11D may be actually performed at the position m5, and the arrangement may have two additional nozzles.

When the motion amplitude of the carriage 106 in which the printhead 111 is mounted is too large, the ink ejected from a nozzle is not deposited on a desired area due to the acceleration/deceleration of the carriage 106. To prevent this, the carriage 106 may be reciprocally moved with a motion amplitude of no more than five times the nozzle pitch in either and/or both directions (i.e., ten total nozzle pitches).

According to the above described structures and methods, the embodiments of the present general inventive concept perform a printing operation by reciprocally moving a carriage when a nozzle malfunctions or when printing in a high-resolution mode.

As described above, a high resolution printing method according to the embodiments of the present general inventive concept changes a position where ink is ejected from a selected nozzle by moving a printhead, when a nozzle malfunctions or when printing in a high-resolution mode. Since an actual resolution of the printhead is determined by a nozzle pitch, the method according to the embodiments of the present general inventive concept can enhance the printing resolution by ejecting ink between ink dots ejected on the print medium during the motion of the printhead in the above-described manner. In addition, when some nozzles in the printhead malfunction, the method according to the embodiments of the present general inventive concept can reduce image degradation, such as generation of a white band that results from a malfunctioning nozzle using an adjacent nozzle to compensate for the malfunctioning nozzle(s) by moving the printheadlongitudinally. Accordingly, the image forming apparatus and the high resolution printing method according to the embodiments of the present general inventive concept can compensate for a malfunctioning nozzle and realize a high resolution printing quality by controlling a moving distance and a number of moving times of the printhead. In addition, the image forming apparatus and the high resolution printing method can minimize an ink registration error due to the acceleration/deceleration of the printhead by ejecting ink at or near a uniform velocity zone of the printhead when a malfunctioning nozzle is compensated for or when the high resolution printing is performed. The image forming apparatus and the high resolution printing method according to the embodiments of the present general inventive concept can provide a sufficient time interval between the ink ejection when compensating for the malfunctioning nozzle or when performing the high resolution printing, thereby allowing the ink a sufficient time to dry, regenerating the vanished ink meniscus, and minimizing a cross-talk according to the ink ejection. Therefore, a reliable printing image quality can be obtained.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An inkjet image forming apparatus comprising:
a print medium transferring unit to transfer a print medium in a first direction;
a printhead having a nozzle unit with a length that corresponds to at least a width of the print medium installed along a second direction to eject ink onto the print medium to form an image;
a carriage movably installed in the second direction and in which the printhead is installed;
a carriage moving unit to reciprocally move the carriage in the second direction;
a detecting unit to detect whether a malfunctioning nozzle exists in the nozzle unit; and
a control unit to generate control signals to move the carriage by a single nozzle pitch “n” times with a motion amplitude in the range of more than a single nozzle pitch to the length of the nozzle unit when printing an image that corresponds to a single pixel line and a malfunctioning nozzle is detected, and to synchronously control the transferring operation of the print medium transferring unit, the ejecting operation of the printhead, and the operation of the carriage moving unit to compensate for the malfunctioning nozzle by ejecting ink when an adjacent nozzle is moved to a position where the malfunctioning nozzle is positioned for a previous ejection.

2. The apparatus of claim 1, wherein the control unit generates a control signal to eject ink for compensation before the carriage arrives at a position that corresponds to a maximum motion amplitude.

3. The apparatus of claim 1, wherein the control unit generates a control signal that drives only the adjacent nozzle that is moved to the position where the malfunctioning nozzle is positioned for the previous ejection.

4. The apparatus of claim 1, wherein the control unit generates a control signal to control the carriage to have a motion amplitude of no more than five times a single nozzle pitch.

5. An inkjet image forming apparatus comprising:
a print medium transferring unit to transfer a print medium in a first direction;
a printhead having a nozzle unit with a length that corresponds to at least a width of the print medium installed along a second direction to eject ink onto the print medium to form an image;
a carriage movably installed in the second direction and in which the printhead is installed;
a carriage moving unit to reciprocally move the carriage in the second direction; and
a control unit to generate control signals that move the carriage in a stepwise manner by a magnitude of D/N for “n” times with a motion amplitude in a range of more than a single nozzle pitch to the length of the nozzle unit when printing an image that corresponds to a single pixel line during a high resolution printing operation, and to synchronously control the transferring operation of the print medium transferring unit, the ejecting operation of the printhead, and the operation of the carriage to enhance a resolution by ejecting ink onto each position of a D/N interval between two adjacent nozzles, where “D” is a nozzle pitch, “n” is a predetermined natural number, and N is a ratio of a desired printing resolution to an actual resolution of the printhead.

6. The apparatus of claim 5, wherein the control unit generates a control signal to eject ink at each time after the carriage moves by more than a single nozzle pitch when printing with high resolution.

7. The apparatus of claim 5, further comprising:
a detecting unit to detect whether a malfunctioning nozzle exists in the nozzle unit, and when a malfunctioning nozzle is detected, the control unit generates a control signal to eject ink to compensate for the malfunctioning nozzle when an adjacent nozzle is moved to a position where the malfunctioning nozzle is positioned for a previous ejection.

8. The apparatus of claim 7, wherein the control unit generates a control signal that drives only the adjacent nozzle that is moved to the position where the malfunctioning nozzle is positioned for the previous ejection.

9. The apparatus of claim 7, wherein the control unit generates a control signal to eject ink to compensate before the carriage arrives at a position that corresponds to a maximum motion amplitude when the carriage has moved by a distance that is larger than a single nozzle pitch.

10. The apparatus of claim 9, wherein the control unit generates a control signal to eject ink for the high resolution printing while the carriage is moved in reverse from the maximum motion amplitude.

11. The apparatus of claim 10, wherein the control unit generates a control signal to eject ink to compensate for the malfunctioning nozzle during the high resolution printing after the carriage moves by more than a single nozzle pitch.

12. The apparatus of claim 5, wherein the control unit generates a control signal to control the carriage to have a motion amplitude of no more than five times a single nozzle pitch.

13. The apparatus of claim 5, wherein N is equal to 2.

14. The apparatus of claims 5, wherein the control unit generates a control signal to transfer the print medium at a “1/n” speed with respect to a print medium transferring speed of a normal printing mode.

15. An image forming apparatus, comprising:
a printhead having a length that corresponds to at least a width of a print medium and a predetermined nozzle pitch; and
a control unit to control the printhead to move back and forth with a motion range of at least two times the predetermined nozzle pitch.

16. The image forming apparatus of claim 15, wherein the control unit operates the printhead in one or more of:
a first mode in which printing is performed with a high resolution such that an initial ink ejection is performed to eject a first plurality of ink dots and one or more subsequent ink ejections are performed when the printhead is moved by the control unit to eject a second plurality of ink dots in between the first plurality of ink dots;
a second mode in which printing is performed to compensate for one or more malfunctioning nozzles such that the initial ink ejection is performed to eject the first plurality of ink dots and one or more subsequent ink ejections are performed when the printhead is moved by the control unit to eject one or more ink dots to compensate for the one or more malfunctioning nozzles in the printhead; and
a third mode performed to print with the high resolution and to compensate for the one or more malfunctioning nozzles.

17. The image forming apparatus of claim 15, wherein the motion range includes at least one nozzle pitch on a first side of an initial position of the printhead and at least one nozzle pitch on a second side of the initial position of the printhead such that the control unit reciprocates the printhead on both sides of the initial position.

18. The image forming apparatus of claim 15, wherein the motion range includes the at least two nozzle pitches to one side of an initial position of the printhead.

19. The image forming apparatus of claim 15, wherein the control unit controls the printhead to eject ink from a functioning nozzle to compensate for a malfunctioning nozzle when the printhead reaches an end of the motion range.

20. The image forming apparatus of claim 15, wherein the control unit controls the printhead to move in a stepwise manner in steps that are less than the motion range.

21. The image forming apparatus of claim 15, further comprising:
a detecting unit to detect a malfunctioning nozzle in the printhead and to provide a detection signal to the control unit.

22. An image forming apparatus, comprising:
a printhead having a plurality of nozzles extending along at least a width of a print medium; and
a control unit to control the printhead to move back and forth with respect to an initial position with a motion amplitude of between one nozzle pitch and five nozzle pitches to perform a plurality of ink ejection operations to form a single pixel line.

23. An image forming apparatus comprising:
a printhead having a plurality of nozzles extending along at least a width of a print medium and a predetermined nozzle pitch; and
a control unit to control the printhead to eject ink and to move the printhead from an initial position thereof with a motion amplitude that is a multiple of the predetermined nozzle pitch of the printhead in a plurality of steps that are a fraction of the predetermined nozzle pitch of the printhead.

24. The image forming apparatus of claim 23, wherein the control unit controls the printhead to eject ink at the initial position, controls the printhead to move from the initial position by (D/N) a predetermined number of times (n), and controls the printhead to eject ink between each movement, where (D) represents the nozzle pitch and (N) represents a ratio between an actual resolution of the printhead defined by the predetermined nozzle pitch (D) and a desired resolution.

25. The image forming apparatus of claim 24, further comprising:
a printing environment information unit to store information about printing environments, to receive the desired resolution from a host device, and to compare the desired resolution with the actual resolution of the printhead to determine the ratio (N) between the actual resolution and the desired resolution.

26. The image forming apparatus of claim 25, further comprising:
a medium transferring unit to transfer the print medium in a transferring direction at a speed of (1/n) with respect to a normal transferring speed, when the desired resolution is greater than the actual resolution.

27. An image forming apparatus comprising:
a printhead having a plurality of nozzles extending along at least a width of a print medium; and
a control unit to control the printhead to print at an initial position, to reciprocate with a motion amplitude with respect to the initial position such that the printhead ejects ink to compensate for a malfunctioning nozzle when the printhead is being moved from the initial position toward a maximum motion amplitude position and the printhead ejects ink to increase a resolution of the initial position print while the printhead is being moved back from the maximum motion amplitude position toward the initial position.

28. An image forming apparatus comprising:
a printhead having a plurality of nozzles extending along at least a width of a print medium; and
a control unit to control the printhead to print at an initial position such that a plurality of initial ink dots are ejected to the print medium and to reciprocate the printhead with respect to the initial position in first and second directions such that the control unit controls the printhead to perform a malfunctioning nozzle compensation operation when the printhead is moved in the first direction and the control unit controls the printhead to perform a high resolution print operation between the initial ink dots when the printhead is moved in the second direction.

29. An image forming apparatus comprising:
a printhead having a width that extends along at least a width of a print medium and having an actual resolution; and
a control unit to operate the printhead betweeen a normal printing mode in which a printing resolution is equal to the actual resolution, a high resolution mode in which the printhead is reciprocated with respect to an initial printing position while ink is ejected between initial ink dots such that the printing resolution is greater than the actual resolution, a compensation printing mode in which the printhead is reciprocated with respect to the initial printing position while a selected functioning nozzle prints to a position on the print medium that corresponds to a malfunctioning nozzle, and a high resolution compensation mode in which the printhead is reciprocated with respect to the initial printing position while ink is ejected between the initial ink dots such that the printing resolution is greater than the actual resolution and the selected functioning nozzle prints to the position on the print medium that corresponds to the malfunctioning nozzle.

30. A high resolution printing method for an inkjet image forming apparatus having a printhead, which has a nozzle unit with a length that corresponds to at least a width of a print medium, and is reciprocally moved for printing, the method comprising:
receiving a desired resolution for printing from a host;
comparing the desired resolution and an actual resolution of the printhead;
printing an image corresponding to a first portion of a single pixel line by ejecting ink onto the print medium;
moving the printhead in a longitudinal stepwise manner by a magnitude of “D/N” for “n” times with a motion amplitude in a range of more than a single nozzle pitch to the length of the nozzle unit, when the desired resolution is greater than the actual resolution of the printhead; and
printing an image that corresponds to a second portion of the single pixel line by ejecting ink onto each position corresponding to a distance of “D/N” between adjacent nozzles in the printhead,
where “D” is a nozzle pitch, 37 n” is a predetermined natural number, and “N” is a ratio of the desired printing resolution to the actual resolution of the printhead.

31. The method of claim 30, wherein the printing of the image that corresponds to the second portion of the single pixel line by ejecting ink onto each position that corresponds to the distance D/N between the adjacent nozzles comprises ejecting ink, for printing each time after the printhead moves by more than a single nozzle pitch when printing with high resolution.

32. The method of claim 30, further comprising:
detecting whether a malfunctioning nozzle exists in the nozzle unit;
storing information about the detected malfunctioning nozzle in a memory; and
compensating for the malfunctioning nozzle by ejecting ink from a nozzle moved to the position where the malfunctioning nozzle is positioned during a previous ejection according to the information stored in the memory.

33. The method of claim 32, wherein only the nozzle moved to the position where the malfunctioning nozzle is positioned during a previous ejection is driven.

34. The method of claim 32, wherein the printhead ejects ink to compensate for the malfunctioning nozzle before the printhead arrives at a position that corresponds to a maximum motion amplitude when the printhead has moved by a distance larger than a single nozzle pitch.

35. The method of claim 30, wherein the moving of the printhead further comprises reciprocally moving the printhead within a motion amplitude of no more than five times a single nozzle pitch in either direction with respect to an initial position of the printhead.

36. The method of claim 30, wherein the printing is performed by transferring the print medium at a “1/n” speed with respect to a print medium transferring speed of a normal printing mode.

37. A method of controlling an image forming apparatus having a printhead with a plurality of nozzles extending along at least a width of a print medium, the method comprising:
controlling the printhead to print to the print medium at an initial position; and
controlling the printhead to move by at least one nozzle pitch such that a functioning nozzle that is adjacent to a malfunctioning nozzle prints to a portion of the print medium that corresponds to the malfunctioning nozzle.

38. A method of controlling an image forming apparatus including a printhead having a plurality of nozzles extending along at least a width of a print medium and a predetermined nozzle pitch, the method comprising:
controlling the printhead to eject ink at an initial position; and
controlling the printhead to move from the initial position with a motion amplitude that is a multiple of the predetermined nozzle pitch of the printhead in a plurality of steps that are a fraction of the predetermined nozzle pitch of the printhead.

39. A method of controlling an image forming apparatus including a printhead having a plurality of nozzles extending along at least a width of a print medium, the method comprising:
controlling the printhead to print at an initial position such that a plurality of initial ink dots are ejected to the print medium; and
controlling the printhead to reciprocate with respect to the initial position in first and second directions such that the printhead performs a malfunctioning nozzle compensation operation when the printhead is moved in the first direction and performs a high resolution print operation in between the initial ink dots when the printhead is moved in the second direction.
